(19) United States
(12) Patent Application Publication
(10) Pub. No.: US 2010/0303042 A1
(43) Pub. Date: Dec. 2, 2010

(54) Methods and Arrangements in a Wireless Communication System

(75) Inventors: Johan Bergman, Stockholm (SE); Dirk Gerstenberger, Stockholm (SE)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/740,593

(22) PCT Filed: Oct. 1, 2008
(86) PCT No.: PCT/SE2008/051111

§ 371 Date: Apr. 29, 2010

Related U.S. Application Data
(60) Provisional application No. 60/983,650, filed on Oct. 30, 2007.

(51) Int. Cl. H04W 72/04

(52) U.S. Cl. 370/335

(57) ABSTRACT

The present invention relates to methods and arrangements that enable uplink timing adjustment in a UTRAN while minimizing the signalling overhead. This is achieved by a solution where the information about the estimated reception time is used by the NB to determine whether the UEs need to be time adjusted on the UL in order to avoid TTI overlapping and thus interference. The estimated reception time of a UE UL signal is compared with an ideal reception time (the reference time) which can be defined based on the overall knowledge of the estimated reception times. If the difference between the estimated and the ideal reception time is larger than a pre-defined threshold value, meaning that the overlapping with some other UEs TTI will be big, a timing adjustment is initiated.

### TECHNICAL FIELD

The present invention relates to the area of wireless communications, and especially to uplink timing adjustment in a UMTS Terrestrial Radio Access Network (UTRAN).

### BACKGROUND

The Universal Mobile Telecommunication System (UMTS) is one of the third generation mobile communication technologies designed to succeed GSM. UMTS Terrestrial Radio Access Network (UTRAN) is the radio access network of a UMTS system. The WCDMA technology has been selected as the standard for UTRAN. In the WCDMA architecture, a user equipment (UE) 150 is wirelessly connected to NodeB (NB) 130a-c, which in turn are connected to radio network controllers (RNC) 100 a-b, as illustrated in FIG. 1.

Illustrated in FIG. 2a, an RNC 210 is connected to an NB 230, which in turn is serving two UEs 251, 252. In a WCDMA radio network like this one, the signals on the downlink (DL) dedicated channels of the different UEs in a cell are 256 chip time aligned, in order to obtain orthogonality. This will be explained below taking the network in FIG. 2a as an example and with reference to FIG. 2b. The two UEs 251, 252 in this cell served by the same NB 230, has each of them a dedicated timing τ_{dpch} 261, 262 relative to the NB time reference 220. The dedicated timing per UE 261, 262 is given in units of 256 chip (τ_{dpch}=k*256, where k is an integer), and secures that the signals on the UEs dedicated channels 271, 272 are time aligned on the DL. If the first UE 251 has a dedicated timing 261 of τ_{dpch}=1*256, and the second UE 252 has a dedicated timing 262 of τ_{dpch}=2*256, then their signals will be aligned with a separation of 256 chip. It is the RNC that controls the τ_{dpth} values and that informs the NB and the UE about what value to use. The RNC 210 thus informs the NB 230 and both the first UE 251 and the second UE 252 about the dedicated timing for each of the UEs.

When the DL signal 302 arrives at the UE, it is delayed compared to the signal sent from the NB 301 due to the DL propagation delay 310, which is illustrated in FIG. 3. The propagation delay varies for the different UEs in a cell, depending on their distance from the NB. The corresponding signal on the uplink (UL) 303 is sent to the NB with a certain constant delay 330˜T₀ (in principle the same delay for all UEs, except for UEs in soft handover) relative to the received DL signal 302, and this uplink signal 303 is of course also subject to an UL propagation delay 320 before it is being received at the NB 304. Thus, as the round trip time (i.e. the sum of the UL and DL propagation delay) varies between the different UEs in a cell, the different UE signals on the UL dedicated channels in a cell are typically not time aligned. Also multipath and soft handover affects the time alignment on the UL. At soft handover (i.e. when a UE is simultaneously connected to two or more cells during a call), the UL timing at the UE may vary +/−128 chip from the value of ˜T₀.

The UL time alignment for a UE thus mainly follows the DL time alignment and is affected by the RNCs choice of τ_{dpch}, but it cannot be completely controlled mainly due to the varying round trip time for the different UEs in a cell, and a misalignment may thus occur on the uplink. For low rates, the lack of UL time alignment has not been seen as a big problem, but when the peak rates are becoming higher and higher the UL interference is becoming more and more important.

In the 3GPP (3^{rd} Generation Partnership Project), a solution has been discussed, which is providing a possibility to time adjust the signals on the UL dedicated channels to some extent. In this solution, a small fraction (typically every 15:th one) of the Transmit Power Control (TPC) symbols on the Dedicated Physical Channel (DPCH) is used to transmit timing adjustment commands periodically from the NB to the UE. This solution will in the following be referred to as the TPC solution.

The purpose of the TPC solution is to achieve better orthogonality by aligning the symbols from different UEs and thus to adjust the timing at a sub chip level, typically +/−¼ of a chip. One problem with the TPC solution is that larger time adjustments, like time adjustments of up to 256 chip needed to avoid that different UEs have overlapping transmission time intervals (TTIs), would take very long time to perform.

Furthermore, the TPC solutions periodic timing adjustment commands may be an unnecessarily wasteful approach. How often to send the commands need to be dimensioned for the worst case, meaning that in many scenarios the number of commands will be unnecessarily high and hence the signaling overhead unnecessarily large. There will be signaling resources dedicated for timing adjustments even though it might not be needed from an interference perspective. Another implementation dependent drawback is that if the timing adjustment command is implemented as a binary command, i.e. a +/−1 time step, there will be periodic timing adjustments in one direction (+1 time step) or the other (−1 time step) no matter whether they are needed or not.

Finally, a further drawback with the TPC solution is that it doesn't work with legacy UEs (e.g. UEs specified according to 3GPP Release 99), as these cannot be made to interpret the TPC symbols as timing adjustment commands.

### SUMMARY

The object of the present invention is to provide methods and arrangements that obviate some of the above disadvantages and that let the NB determine which UEs in a cell that need to be time adjusted on the uplink, and then enables the NB to initiate a time adjustment of these UEs.

This is achieved by a solution where the information about the estimated reception time is used by the NB to determine whether the UEs need to be time adjusted on the UL, in order to avoid TTI overlapping and thus interference. The estimated reception time of a UE UL signal is compared with an ideal reception time (the reference time) defined based on the knowledge of the estimated reception times of all UEs. If the difference between the estimated and the ideal reception time is larger than a pre-defined threshold value, meaning that the overlapping with some other UEs TTI will be big, a timing adjustment is initiated.

Thus in accordance with a first aspect of the present invention, a method is provided for uplink timing adjustment for a NB where the NB receives signals from user equipment. The method comprises the steps of calculating a difference between an estimated reception time of a user equipment signal and a time reference, and determining whether the difference exceeds a pre-defined threshold value. The method also comprises the step of initiating the uplink timing adjustment when the difference exceeds the pre-defined threshold value.

In accordance with a second aspect of the present invention, a method of uplink timing adjustment for a RNC is provided. The method comprises the steps of receiving a downlink timing adjustment request over lub or lub/lur, which is based on a calculated difference between an estimated reception time of a user equipment signal and a time reference. It also comprises the step of adjusting the downlink timing according to the request.

In accordance with a third aspect of the present invention, a method is provided for uplink timing adjustment for a UE where the user equipment sends signals to a NB with a certain uplink timing. The method comprises the steps of receiving an uplink timing adjustment command on a channel, which is based on a calculated difference between an estimated reception time of a user equipment signal and a time reference. It also comprises the step of adjusting the uplink timing according to the command.

In accordance with a fourth aspect of the present invention, a NB adapted to receive signals from user equipment is provided. The NB comprises means for calculating a difference between an estimated reception time of a user equipment signal and a time reference, and means for determining whether the difference exceeds a pre-defined threshold value. It also comprises means for initiating the uplink timing adjustment.

In accordance with a fifth aspect of the present invention, an RNC is provided. The RNC comprises means for receiving a downlink timing adjustment request over lub or lub/lur, which is based on a calculated difference between an estimated reception time of a user equipment signal and a time reference. It also comprises means for adjusting the downlink timing according to the request.

In accordance with a sixth aspect of the present invention, a UE, where the user equipment is adapted to send signals to a NB with a certain timing, is provided. The UE comprises means for receiving an uplink timing adjustment command on a channel, which is based on a calculated difference between an estimated reception time of a user equipment signal and a time reference. It also comprises means for adjusting the uplink timing according to the command.

An advantage of embodiments of the present invention is that they make it possible to limit the time adjustment only to the UEs that really need it, avoiding a periodic adjustment and thus minimizing the signalling overhead.

### BRIEF DESCRIPTION OF THE DRAWINGS

FIG. 1 illustrates schematically a part of, e.g., a WCDMA system wherein the present invention may be implemented.

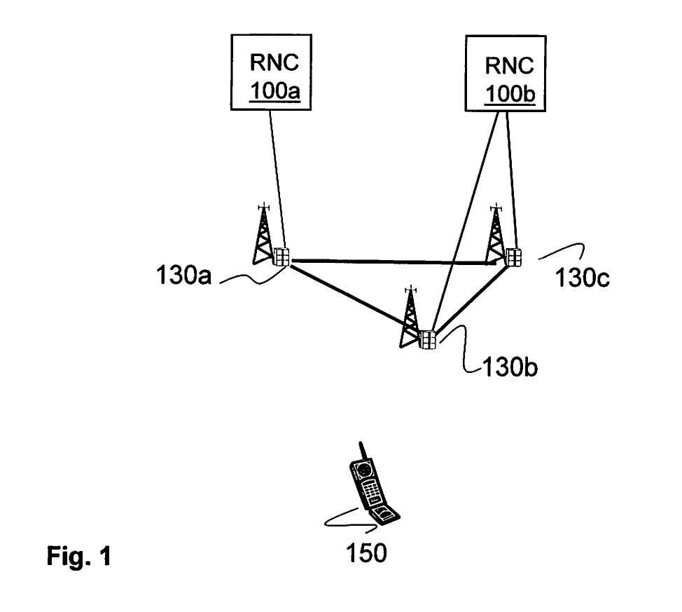

FIG. 2a illustrates schematically a part of, e.g., a WCDMA system wherein the present invention may be implemented.

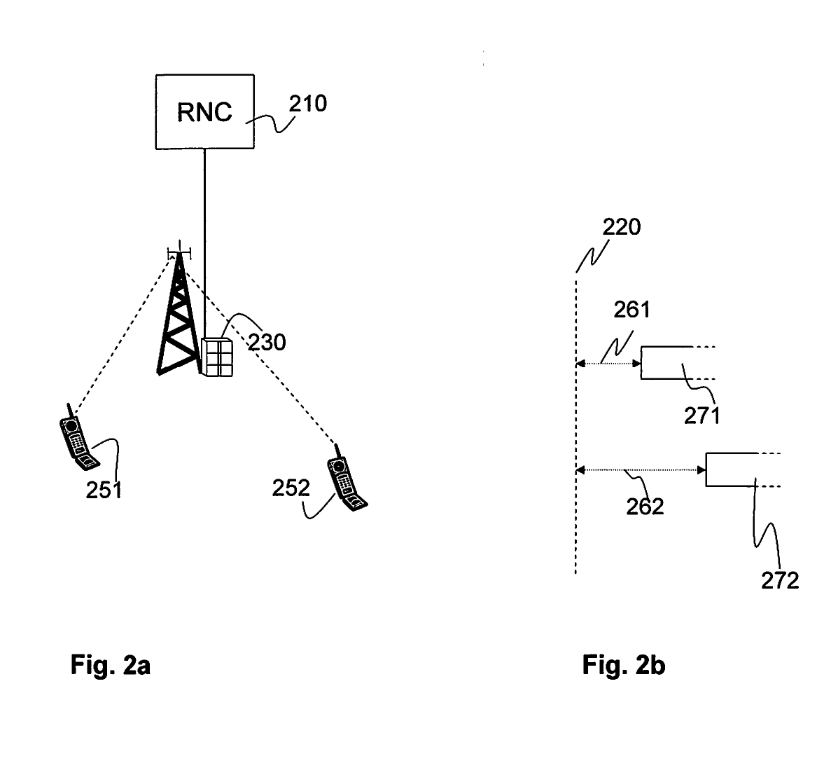

FIG. 2b illustrates schematically the timing alignment of two UE signals on the DL.

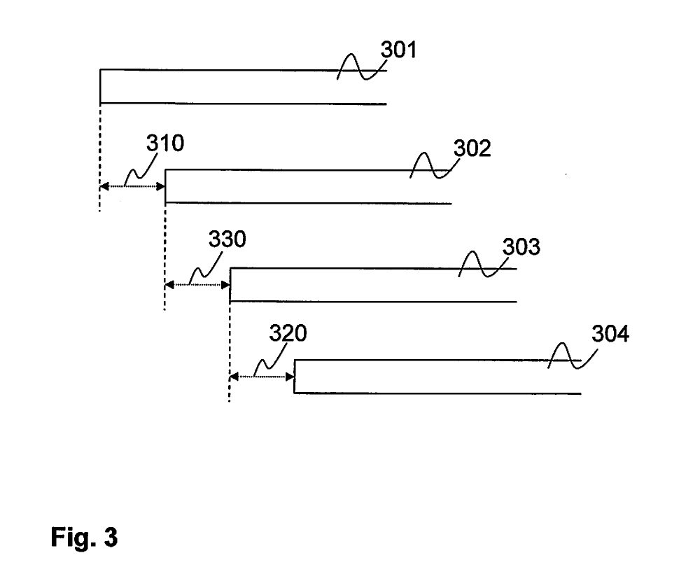

FIG. 3 illustrates schematically the delays of a signal on the DL and UL.

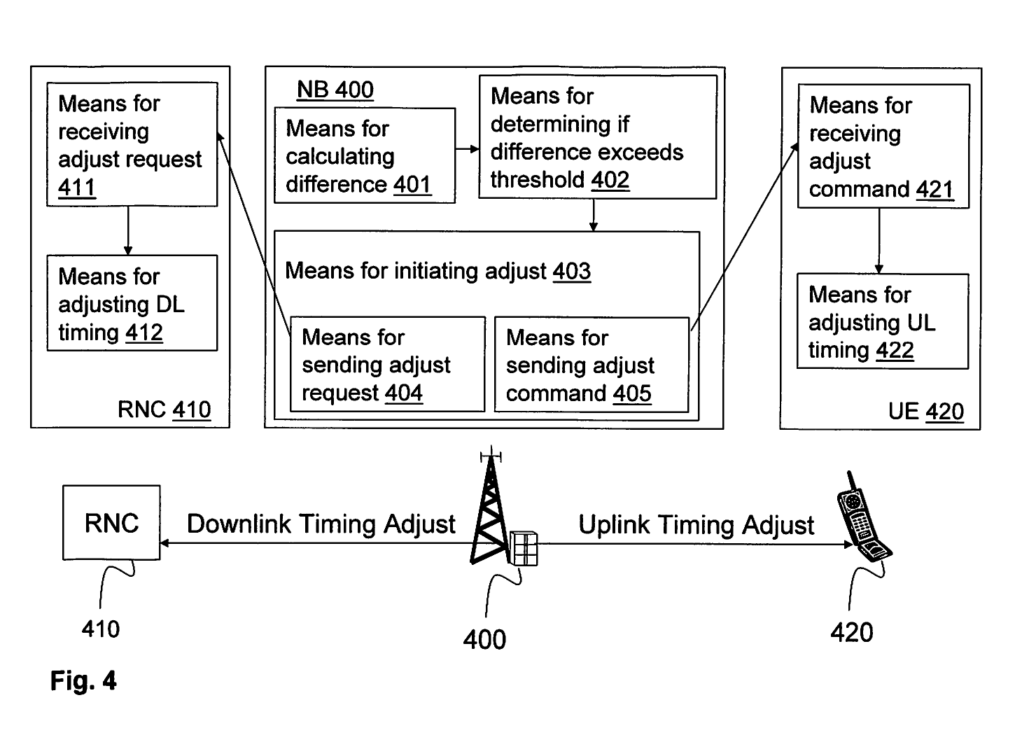

FIG. 4 illustrates schematically the RNC, NB and UE according to embodiments of the present invention.

FIGS. 5a, 5b and 5c are flowcharts of the methods of the NB, RNC and UE respectively according to embodiments of the present invention.

### DETAILED DESCRIPTION

In the following, the invention will be described in more detail with reference to certain embodiments and to accompanying drawings. For purposes of explanation and not limitation, specific details are set forth, such as particular scenarios, techniques, etc., in order to provide a thorough understanding of the present invention. However, it will be apparent to one skilled in the art that the present invention may be practiced in other embodiments that depart from these specific details.

Moreover, those skilled in the art will appreciate that the functions and means explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as in a system comprising a computer processor and a memory coupled to the processor, wherein the memory is encoded with one or more programs that may perform the functions disclosed herein.

The present invention uses the fact that the NB can gather information about the estimated reception time of the UL signals of all the UEs. Based on this information, the NB can determine whether signals from the different UEs in a cell will be aligned in time, and will thus be able to tell what UEs that need to be time adjusted on the UL. The advantage of doing this is that it makes it possible to limit the time adjustment only to the UEs that really need it, avoiding a periodic adjustment and thus minimizing the signaling overhead.

The purpose of time adjusting the signals is to align the UEs relative to each other so that the NB scheduler can schedule data transmissions from different UEs with as little TTI overlap as possible, which will reduce the interference. This is important especially when the peak rates becomes higher, as higher rates makes the system more sensitive to interference.

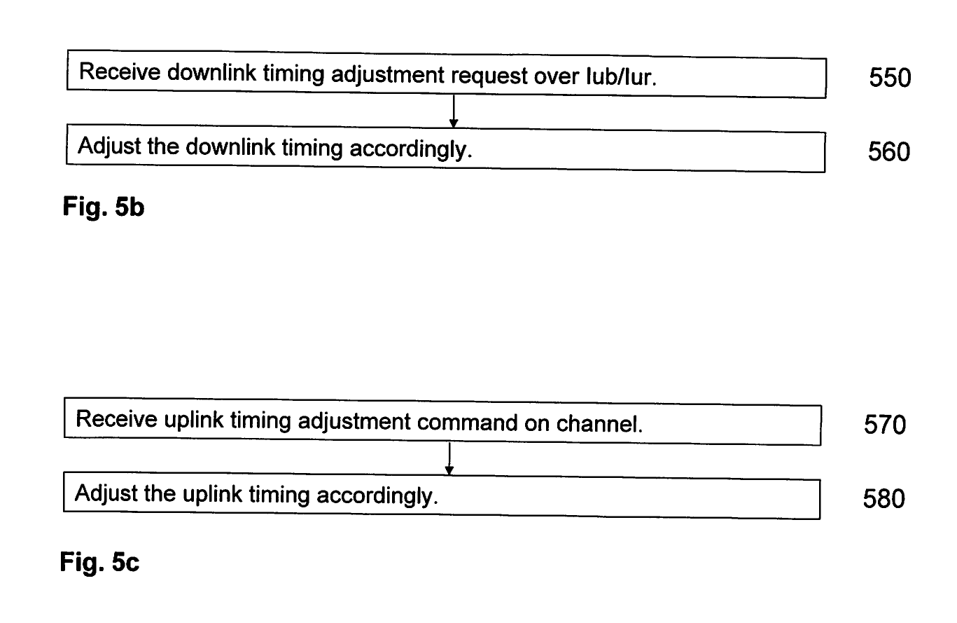

Thus according to one embodiment described with reference to FIG. 5a, the NB calculates 510 a difference between an estimated reception time of a user equipment signal and a time reference, and determines 515 whether the difference exceeds a pre-defined threshold value. The NB also initiates 520 the uplink timing adjustment when the difference exceeds the pre-defined threshold value.

The determination of whether an UL timing adjustment is needed for a certain UE is done by comparing the estimated reception time of this UE signal with a time reference. The time reference corresponds to the desired reception time of the UE signal, i.e. the ideal reception time to avoid interference. If the difference between these points in time is larger than a pre-defined threshold value, then the UE signal needs to be time adjusted in order to avoid too much TTI overlap. The purpose of defining a threshold is to allow for some transmission overlap.

The determination of whether an UL timing adjustment is needed or not, can be done for all UEs served by the NB, and even for UEs that the NB is not serving. But it could also be done for only a part of the UEs. As the NB can get the information about the different UEs contribution to the UL interference, the NB can choose to involve only the most dominating interferers in the determination of what UEs to time align for example.

When it is determined that a UE needs to be time adjusted on the UL, the NB initiates the actual UL timing adjustment by sending a request to the RNC or a command to the UE or both.

In prior art, the RNCs have the possibility to do an indirect time adjustment of the UL signals by adjusting the time alignment on the DL. This is possible as they control the τ_{dpch} for each UE, but the problem is that the RNC does not know when the time adjustment is needed for an individual UE. In the present invention, this possibility is used by letting the NB—that already knows if a time adjust is needed—request a DL time adjustment from the RNC (which indirectly gives an UL time adjustment as well).

In a first embodiment of the present invention, the NB requests a DL timing adjustment from the RNC via the lub (or lub/lur) protocol, with the information about what UE to time adjust and how much adjustment that is needed (based on the difference between the estimated reception time and the reference time). The RNC will use the existing Radio Resource Control (RRC) signaling and the NodeB Application Part (NBAP) signaling to adjust the DL timing, which in turn will affect the UL timing as already described above. In this first embodiment the adjustment is coarse with a resolution of 256 chip. Advantages of this embodiment is that it is applicable both in soft handover and in non soft handover cases and that it can be used for legacy UEs as the mentioned RRC signaling exists in the standard since 3GPP Release 99.

In a second embodiment of the present invention, the initiation of the UL timing adjustment is done by sending an UL timing adjustment command via a High Speed Downlink Packet Access Shared Control Channel (HS-SCCH) order, directly to the UE. An existing order format can be used (according to 3GPP TS 25.212 in Release 7), but one or more new order types need to be defined for this embodiment. The new order type(s), comprised in the HS-SCCH order, will indicate that the content is an UL timing adjustment command and how much the timing should be adjusted. Upon reception of such an order, the UE can adjust its timing accordingly. In an alternative embodiment, special values on an Enhanced UL Absolute Grant Channel (E-AGCH) can be used instead of HS-SCCH orders. In both of these two alternatives, the advantage is that the adjustment resolution can be either small (a few chip) or big (hundreds of chip), and that the complete time adjustment is done at once either it is small or big. As these embodiments do not involve the RNC, they also provide a quicker adjustment than in the first embodiment described above. Another advantage is that it is possible to make an adjustment on chip level and not just on a 256 chip level.

In a third embodiment of the present invention, the initiation of the UL timing adjustment is a combination of the first and the second embodiment described above. As an example, the method of the first embodiment can then be used for a coarse adjustment in the order of a multiple of 256 chip adjustment, and the method of the second embodiment can be used for fine adjustments in the order of one or a few chip adjustments.

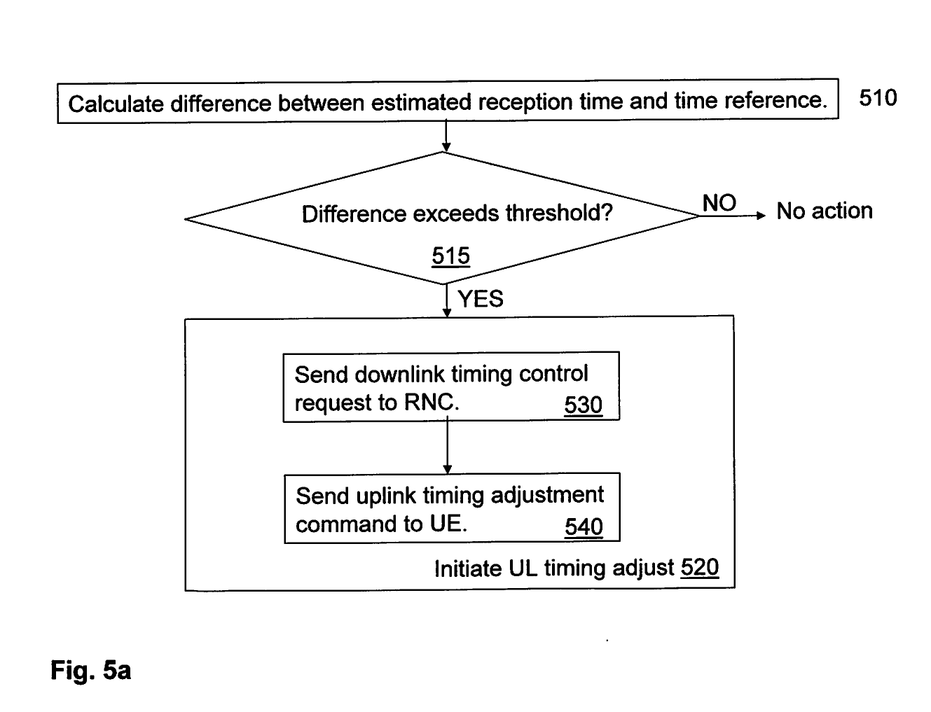

Schematically illustrated in FIG. 4 and according to the third embodiment described above, the NB 400 comprises means for calculating 401 the difference between an estimated reception time and a time reference. It also comprises mean for determining 402 whether the calculated difference exceeds a pre-defined threshold or not, and means for initiating 403 the uplink timing adjustment. The means for initiating 403 the uplink timing adjustment comprises in turn means for sending 404 an UL timing adjust request to the RNC and means for sending 405 an UL timing adjustment command on a channel. The channel can be either the HS-SCCH or the E-AGCH, as described above.

Also illustrated in FIG. 4 is the RNC 410. It comprises means for receiving 411 a DL timing adjustment request over lub or lub/lur from the NB, and means for adjusting 412 the timing on the DL accordingly.

Further illustrated in FIG. 4 is the UE 420. It comprises means for receiving 421 an UL timing adjustment command from the NB, and means for adjusting 422 the timing on the UL accordingly.

FIG. 5a is a flowchart of the method for the NB, according to the third embodiment of the present invention as described above. In step 510 the difference between an estimated reception time of a UE and a time reference is calculated. The time reference corresponds to a desired reception time in order to avoid interference. A comparison of the desired reception time and the estimated reception time will give an indication if the corresponding UE will need to be time aligned or not. In step 515 it is determined if the difference exceeds a pre-defined threshold value, and if it does, a timing adjustment is initiated in step 520. If the difference does not exceed the pre-defined threshold, there is no need for a timing adjustment for the UE, and no action is taken. There can thus be a certain difference between the estimated reception time and the time reference (although lower than the pre-defined threshold value) without initiating a timing adjustment, which means that a certain TTI overlapping is accepted. Step 520 comprises of two steps: step 530 and step 540. In step 530, a DL timing control request is sent to the RNC. The DL timing control request will include an indication of how much the DL should be adjusted, and this will thus indirectly affect the UL timing. In step 540, an UL timing adjustment command is sent on a channel to the UE. This will directly affect the UL timing adjustment. In step 530, the adjustment is coarse, and it is complemented with the adjustment of step 540, which allows for a finer adjustment.

FIG. 5b is a flowchart of the method for the RNC, according to the third embodiment of the present invention as described above. In step 550, the RNC receives a DL timing adjustment request over lub or lub/lur from the NB, and in step 560 the RNC adjusts the DL timing according to the request. This will then indirectly affect the UL timing.

Furthermore, FIG. 5c is a flowchart of the method for the UE, according to the third embodiment of the present invention as described above. In step 570, the UE receives an UL timing adjustment command from the NB on a HS-SCCH or on a E-AGCH, and in step 580 the UE adjusts the uplink timing according to the received command. The command includes information about the magnitude of the time adjustment needed in order to avoid TTI overlapping with other UEs.

The above mentioned and described embodiments are only given as examples and should not be limiting to the present invention. Other solutions, uses, objectives, and functions within the scope of the invention as claimed in the accompanying patent claims should be apparent for the person skilled in the art.

1-14. (canceled)

15. A method of uplink timing adjustment of a user equipment in a WCDMA communications system, said system comprising a Radio Network Controller (RNC) connected to a NodeB, said NodeB receiving signals from the user equipment, and said method comprising the following steps performed by the NodeB:
calculating a difference between an estimated reception time of a user equipment signal and a time reference;
determining whether said difference exceeds a pre-defined threshold value; and
initiating the uplink timing adjustment only when said difference exceeds the pre-defined threshold value.

16. The method according to claim 15, wherein the step of initiating the uplink timing adjustment comprises the further step of sending a downlink timing control request to the RNC, which is based on a calculated difference between an estimated reception time of a user equipment signal and a time reference, in order for the RNC to adjust the downlink timing.

17. The method according to claim 16, wherein the step of initiating the uplink timing adjustment comprises the further step of sending an uplink timing adjustment command on a High Speed Downlink Packet Access Shared Control Channel.

18. The method according to claim 16, wherein the step of initiating the uplink timing adjustment comprises the further step of sending an uplink timing adjustment command on an Enhanced Uplink Absolute Grant Channel.

19. A method of uplink timing adjustment of a user equipment in a WCDMA communications system, said system comprising a Radio Network Controller (RNC) connected to a NodeB, wherein the user equipment sends signals to the NodeB with a certain uplink timing, and wherein the method comprises the following steps performed by the user equipment:
receiving an uplink timing adjustment command on a channel, only when a calculated difference between an estimated reception time of the user equipment signal and a time reference exceeds a pre-defined threshold value; and
adjusting the uplink timing according to the command.

20. The method according to claim 19, wherein the channel is a High Speed Downlink Packet Access Shared Control Channel.

21. The method according to claim 19, wherein the channel is an Enhanced Uplink Absolute Grant Channel.

22. A NodeB of a WCDMA communications system, wherein said NodeB is configured for connecting to a Radio Network Controller (RNC) and receiving signals from user equipment, and wherein the NodeB comprises one or more processing circuits configured to:
calculate a difference between an estimated reception time of a user equipment signal and a time reference;
determine whether said difference exceeds a pre-defined threshold value; and
initiate an uplink timing adjustment only when said difference exceeds the pre-defined threshold value.

23. The NodeB according to claim 22, wherein, to initiate the uplink timing adjustment, the NodeB is configured to send a downlink timing control request to the RNC, which is based on a calculated difference between an estimated reception time of a user equipment signal and a time reference, in order for the RNC to adjust the downlink timing.

24. The NodeB according to claim 23, wherein, as part of initiating the uplink timing adjustment, the NodeB is configured to send an uplink timing adjustment command on a High Speed Downlink Packet Access Shared Control Channel.

25. The NodeB according to claim 23, wherein, as part of initiating the uplink timing adjustment, the NodeB is configured to send an uplink timing adjustment command on an Enhanced Uplink Absolute Grant Channel.

26. A user equipment of a WCDMA communication system, said system comprising a Radio Network Controller (RNC) connected to a NodeB, wherein the user equipment is configured to send signals to the NodeB with a certain timing, and wherein the user equipment comprises one or more processing circuits configured to:
receive an uplink timing adjustment command on a channel, only when a calculated difference between an estimated reception time of the user equipment signal and a time reference exceeds a predefined threshold value; and
adjust the uplink timing according to the command.

27. The user equipment according to claim 26, wherein the channel is a High Speed Downlink Packet Access Shared Control Channel.

28. The user equipment according to claim 26, wherein the channel is an Enhanced Uplink Absolute Grant Channel.
